(19) United States
(12) Patent Application Publication
(10) Pub. No.: US 2006/0013760 A1
(43) Pub. Date: Jan. 19, 2006

(54) Autothermal reforming catalyst

(75) Inventors: Yanlong Shi, Littleton, MA (US); Prashant Chintawar, Marlborough, MA (US)

Correspondence Address: FINCH IP LLC, P.O. BOX 1358, CONCORD, NH, 03302, US

(73) Assignee: Nuvera Fuel Cells, Inc.

(21) Appl. No.: 11/112,442

(22) Filed: Apr. 22, 2005

Related U.S. Application Data
(63) Continuation of application No. PCT/US03/32592, filed on Oct. 16, 2003.
(60) Provisional application No. 60/421,415, filed on Oct. 25, 2002.

(51) Int. Cl. C01B 3/32

(52) U.S. Cl. 423/648.1; 502/304

(57) ABSTRACT

A catalyst and methods of production and use are provided. The catalyst may be used to reform fuels to hydrogen for use in fuel cells. The fuels may include sulfur.

### RELATED APPLICATIONS

This application is a continuation of PCT Application PCT/US03/32592 filed Oct. 16, 2003 and published as WO 2004/040672 A2 on May 13, 2004, which claims benefit of U.S. Provisional Application 60/421,415, filed Oct. 25, 2002. Each of these applications is incorporated by reference herein.

### BACKGROUND OF THE INVENTION

1. Field of the Invention

The present invention relates to an apparatus and method for reforming fuels into hydrogen and in particular, to the reforming of fuels into hydrogen for use in a fuel cell.

2. Description of the Related Art

Reforming of fuels to make hydrogen is known. There are three types of fuel reforming in general use. In “pure” steam reforming, fuel mixed with steam is passed through a bed of catalyst, and heat is supplied to the bed to drive an endothermic reaction in which a hydrocarbon or oxygenated hydrocarbon is converted to a mixture consisting predominantly of hydrogen (H₂) and carbon monoxide (CO). Steam reforming is typically used with light fuels, such as methane and light complex fuels such as light paraffinic naptha.

Some variants of the basic steam reforming reaction are “partial oxidation” (POX) and “autothermal reforming” (ATR). In POX reforming, part of the fuel is burned with air and introduced into a reactor, along with additional fuel and steam, to provide the heat for the catalytic reforming of the steam/fuel mixture. The exposure of the catalyst to oxygen requires that it be oxidation resistant. POX reforming typically is used for heavier fuels, such as heavy hydrocarbons.

ATR is a refinement of POX reforming. In ATR, fuel, air and steam are mixed and introduced to a catalyst. The proportion of air is selected to provide enough heat from combustion to drive the reformation of the rest of the fuel with the steam. ATR can be used to reform many common liquid and gaseous hydrocarbons.

Known ATR reforming catalysts, such as those based on platinum and nickel, are subject to poisoning by sulfur-containing compounds, particularly H₂S and organic sulfur compounds. Since most grades of petroleum-derived fuels contain sulfur compounds, this can be a significant barrier to the use of gasoline and other common fuels in fuel reformers. Much of the sulfur can be removed before reaching the catalyst, either at the refinery or by a sulfur removal process applied upstream of the reforming catalyst, such as traps, hydrodesulfurization, and other known techniques. Sulfur removal, however, adds expense, and, moreover, traces of sulfur left in the feed can still deactivate the catalyst.

Some vehicle emissions catalysts have been produced using the precious metals platinum, palladium and rhodium together. In the oxidizing environment of a vehicle emissions catalytic converter, this catalyst has been shown to provide improved NO_{X} emissions. (Bartley, G., Bykowski, B., Welstand, S. and Lax, D., Effects of Catalyst Formulation on Vehicle Emissions With Respect to Gasoline Fuel Sulfur Level, SAE TECHNICAL PAPER SERIES 1999-01-3675).

### SUMMARY OF THE INVENTION

It has been discovered that certain catalytic compositions can be effective catalysts of the ATR reaction and can also be resistant to sulfur inactivation.

In one aspect, a method is provided, the method comprising the steps of passing a fuel comprising at least about 10 ppm, by weight, of sulfur, over a catalyst comprising platinum and reforming the fuel to hydrogen at a hydrogen productivity rate that decreases by less than 1% per hour of operation.

In another aspect a system is provided, the system comprising a catalyst in fluid communication with a fuel cell membrane wherein the catalyst comprises a support, three precious metals disposed on the support, and cerium disposed on the substrate at a density of greater than 30 g/L.

In another aspect, a method of producing a catalyst is provided, the method comprising washcoating alumina onto a substrate to provide an alumina concentration of greater than 100 g/L of catalyst volume, washcoating cerium onto the substrate to provide a cerium concentration of greater than 30 g/L of catalyst volume, washcoating lanthanum onto the substrate to provide a lanthanum concentration of greater than 7 g/L of catalyst volume and washcoating three precious metals onto the substrate, the precious metals comprising platinum, palladium and rhodium.

### BRIEF DESCRIPTION OF THE FIGURES

In the drawings:

FIG. 1 graphically illustrates the volume percent of product versus catalyst temperature for several products of fuel reforming resulting from passing gasoline over a catalyst employing one aspect of the invention.

FIG. 2 graphically illustrates catalyst temperature versus product volume percent for several products of fuel reforming resulting from passing gasoline over a second catalyst.

FIG. 3 graphically illustrates volume percent hydrogen over time for three different catalysts reforming California Phase II gasoline.

FIG. 4 graphically illustrates methane production for the same experiment shown in FIG. 3.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the use of readily available hydrocarbon-based fuels, such as gasoline and diesel fuel, would facilitate the introduction of fuel cell-powered vehicles, several hurdles remain before this pre-existing fuel delivery infrastructure can be used. For example, sulfur in gasoline may be poisonous to both a catalyst used to reform hydrocarbons into hydrogen as well as to a PEM. Furthermore, known methods of reforming often result in significant quantities of carbon monoxide downstream of the catalyst, and this carbon monoxide typically needs to be removed or converted to CO₂ prior to its introduction to the PEM.

Different classes or types of catalysts may be used to reform various hydrocarbons into hydrogen. One type of catalyst, typically used for reforming higher molecular weight hydrocarbons into hydrogen, is the “steam reforming” catalyst. In steam reforming (SR), fuel and water are supplied to a catalyst bed that is heated by an outside source of heat. Typically, oxygen is not supplied to the bed of SR catalyst, and historically, SR catalysts have required a reducing environment to maintain activity. Steam reforming may provide a greater conversion efficiency than does a partial oxidation reaction; however, the steam reforming reaction is inherently endothermic and therefore requires a relatively long start-up time in order to obtain optimum temperature for the reforming reaction. In addition, fuels typically must be desulfurized prior to the steam reforming process. Applications for fuel cells that benefit from a short start-up time, such as many transportation applications, may be less likely to use a steam reforming process because of energy input requirements and the relatively long start-up time.

Other types of reactions are the “partial oxidation” and “autothermal reforming” reactions, typically requiring a different type of catalyst. Typically, partial oxidation reactions combine oxidation of fuel with reforming of other fuel in one process stream, either sequentially or simultaneously. The reaction of oxygen with fuel provides heat for fuel reforming, which may occur in the same zone or in a different zone than does the reforming. When the oxidation is non-catalytic, or occurs in an upstream zone distinct from a zone downstream of the oxidation in which more fuel and steam are introduced, the reaction is typically called partial oxidation (“POX”). When fuel, air and steam are combined and introduced together to a single catalytic zone in which some fuel is oxidized and the rest reformed into hydrogen and carbon monoxide, the reaction is typically called autothermal reforming (ATR). Because the catalyst performs both reactions (oxidation and reforming), the creation of a suitable ATR catalyst can be particularly complex. Moreover, when the fuel contains sulfur, particularly organic sulfur that is difficult to remove before the reforming step, it may be preferred that the catalyst also be resistant to poisoning by sulfur. Known ATR catalysts are not highly resistant to sulfur, or to sulfur-containing fuels.
Definitions:

$$Φ ( phi ) = \frac{{( fuel / oxygen )}_{actual}}{{( fuel / oxygen )}_{stoichiometric}}$$

WGHSV=Wet Gas Hour Space Velocity=the volumetric flow rate of the sum of any air, fuel and water (adjusted to STP) through a catalyst body, divided by the catalyst volume, per hour (unit: hr⁻¹).

Precious Metals (PM) include metals from groups VIII and Ib, second and third rows

Rare Earths are those elements having atomic number 57-71, and, for the purposes of convenience of description of this invention, also includes Zirconum (Zr) unless otherwise stated.

The present invention provides a method, apparatus and system for the efficient reforming of a broad range of hydrocarbons to hydrogen. A wide range of fuels may be employed, including some that may contain sulfur. Commonly available fuels such as gasoline may be reformed to hydrogen at more than 70 or 80% production efficiency. Fuel reforming can be achieved with sulfur-containing fuels in a reducing environment.

In one aspect, a catalytic reformer provides a compact and efficient catalyst system for converting sulfur-containing gasoline into hydrogen. Hydrogen production efficiency in this particular context is the percentage of hydrogen created compared to the theoretical maximum.

In one aspect, the sulfur-tolerant ATR catalyst is formulated as a washcoated monolith-based catalyst, for example, on an alumina support. The monolith may have several advantages over a particulate-based ATR catalyst. The advantages may include, for example, higher open surface area/unit volume, lower diffusion distance, reduced pressure drop, better heat transfer, lower cost, improved mechanical strength and toughness, and better thermal shock resistance.

A secondary process frequently used in fuel reforming for fuel cell applications is the water-gas shift reaction (WGS) that can be used to oxidize carbon monoxide to carbon dioxide while forming hydrogen from water. Typically, the WGS reaction is represented by
CO+H₂O→CO₂+H₂ (eqn. 1)

The WGS reaction is typically employed to produce additional hydrogen from the CO (carbon monoxide) that may be formed in the reforming reaction, and to reduce levels of carbon monoxide to avoid CO poisoning of the fuel cell. Because the WGS reaction may be conducted at lower temperatures than the reforming reaction, ATR catalysts are typically not optimized for WGS activity. The reforming catalyst disclosed herein may present some WGS activity as well as its other activities.

In another aspect, the catalyst disclosed herein may be resistant to coking, which can be prevalent with known reforming catalysts, particularly when the fuel includes olefins. In one embodiment, the catalyst may be active for reforming all molecular species of a broad range of hydrocarbons, including olefins and aromatics and may be sulfur tolerant. The catalyst may be highly active per unit volume, so that, for example, the reactor may be compact, and hence may be operated with a relatively short start-up time (to reach operating temperature). This feature may be preferred in, for example, vehicular applications. In another embodiment, a single catalyst body including a single catalyst formulation may be used to reform a fuel that is composed of a broad range of hydrocarbons, for example, aliphatic, aromatic and olefinic hydrocarbons. Downstream of the single catalyst, one or more WGS reactors may be used to reduce carbon monoxide and to increase hydrogen content.

In one aspect, the catalyst disclosed herein is suitable for use with a variety of hydrocarbon-based fuels. These hydrocarbons may include aromatic and aliphatic hydrocarbons as well as olefins. Notably, olefins (and other fuels) can be reformed with little or no coking. Fuels that may be useful include gasoline, kerosene, jet fuel, diesel fuel, alcohols such as ethanol and methanol, and lower molecular weight hydrocarbons such as butane, propane and methane.

In another aspect, fuels can be reformed that may contain levels of sulfur that typically would need to be removed prior to use. While hydrogen sulfide can be routinely removed from a fuel stream, organic forms of sulfur, such as thiophenes and benzothiophenes, are difficult to remove and may eliminate a fuel from consideration as a hydrogen source. These organic sulfur compounds, and others, may be present in fuels at concentrations up to or greater than 100 parts per million (ppm). For example, in one embodiment, gasoline that contains 10, 20, 30, 35 or more than 35 ppm sulfur, by weight, may be used. A specific example of a fuel that can be reformed is “California Phase II” gasoline, which contains about 35 ppm sulfur, primarily as thiophenes and benzothiophenes. However, much lower amounts of sulfur, such as ppb levels, can inhibit fuel cells. Thus, fuels containing as little as 1 ppm, 100 ppb, or even 10 ppb of sulfur, by weight, may be used in a fuel cell system with the disclosed catalyst while known catalysts might fail under the same conditions. In one embodiment, the catalyst may be used to convert organic sulfur to hydrogen sulfide by passing a sulfur-containing fuel over the catalyst.

In another aspect, the improved catalyst may be formed on any substrate that allows the catalyst to be in catalytic contact with the fuel being reformed. The substrate may have a relatively high surface area, may be easily heated and may be able to maintain a high temperature during operation. It may be smaller and lighter than systems that employ classical steam reforming catalysts.

In one embodiment, the catalyst is multi-metallic precious metal (PM)-based, and the precious metals may include platinum (Pt), palladium (Pd) and/or rhodium (Rh).

Pt can exhibit, for example, activity for oxidation of saturated hydrocarbons and good poison tolerance; Pd can exhibit, for example, activity for both olefins and aromatic hydrocarbons, and can provide good CO oxidation performance. Pd also may improve thermal durability. Rh may have both good steam reforming performance and excellent activity in catalyzing the reaction of NH₃ with NOₓ to form N₂, which may help in preventing the formation of NH₃. Rh may also provide good CO oxidation activity. In addition, Pt, Pd and Rh together have been found to display a Pt—Pd—Rh synergism useful in fuel reforming, as described in more detail below.

The substrate on which the catalyst is disposed may be inexpensive to mass produce and may be in the form of pellets or a monolith. It may include an active support on which one or more PMs can be deposited. The pellets or monolith may be made of an inorganic material, such as a metal or ceramic. Other forms include, for example, metal foams and metal foils. Substrates made of cordierite (5SiO₂, 2Al₂O₃, MgO) have been shown to provide a suitable surface for deposition of the catalyst. Other ceramic materials may also be suitable for use in depositing the catalysts of the invention. Such ceramic materials may comprise SiO₂, Al₂O₃, and TiO₂, and may contain additional ceramic materials such as MgO, CaO, and other known ceramic components. Although the ceramic support may be in dispersed form, such as pellets, beads, and small shaped objects, the catalyst support is preferably an extruded monolith. Monoliths used may contain different numbers of cells per square inch (cpsi) and may be in the range of about 300 to about 1200 cpsi, preferably about 600 to about 1200 cpsi, and, in one embodiment, a monolith of about 900 cpsi has been shown to provide efficient reforming at a variety of wet gas hour space velocities (WGHSV). A monolith can also provide a catalyst with a high activity per unit volume, allowing the catalyst to be compact while achieving high reforming efficiency. This may be advantageous with particular applications, such as in vehicles.

In another embodiment, metals may be used for supporting the catalysts and may be in any suitable form. Metal forms include, for example, corrugated metal, extruded or corrugated monoliths, and other physical forms suitable for supporting a catalytic coating.

The catalyst may be formed in a single body that can reform a variety of hydrocarbons, for example, aliphatic, aromatic and olefinic hydrocarbons, at a single common catalytic surface. Applicable fuels include gasoline, and in particular, California Phase II gasoline. One or more WGS reactors may be placed downstream of the catalyst to improve efficiency, for example, by improving hydrogen production and reducing carbon monoxide output.

The components of the catalyst may be applied to the surface or substrate by any one of a variety of methods. Materials such as alumina, rare earths and precious metals may be applied to the surface by “washcoating” appropriate salts onto the surfaces using washcoating techniques known to those skilled in the art. The salts used to washcoat these materials may be any salts, but are preferably salts that do not include a halide, such as chloride, but rather include, for example, nitrates, sulfates or other non-halogen anionic components. Different components of the catalyst may be washcoated onto the substrate in different stages, and after each stage, the substrate may be calcined to fix the materials to the surface.

For example, in one embodiment, a layer of alumina, or similar, may first be washcoated onto the surface, calcined, and followed with a washcoating of rare earths, or salts thereof, such as lanthanum, cerium or zirconium. After these materials have been calcined, another washcoat may follow that includes precious metals such as platinum, palladium, rhodium or ruthenium. In one alternative embodiment, all materials may be washcoated onto the substrate in a single procedure. It may be preferred to washcoat the precious metal components separately, and last, to maximize the exposure of the PM components to the fuel stream. It may also be preferable to apply SMSI (strong metal-support interaction) promoting materials, such as a Ce—Zr layer, as a next-to-last coating layer to prevent or minimize interaction of the PM with any non-SMSI materials in the substrate.

A variety of rare earths may be included in the catalyst and may include those rare earths that provide oxygen vacancies to aid in the reforming process. The rare earths may include the 3+ cation lanthanide series and may include elements selected from La, Pr, Nd, Sm, Eu, Gd, Tb, Dy, Ho, Er, Tm, and Lu, and as noted above, Zr. Those rare earths in which coordination number changeover takes place due to lanthanide contraction may be preferred. These may include Sm, Eu, Gd and Tb. Lanthanum, cerium and zirconium may be used individually or together and may be in the form of oxides, such as ceria (CeO₂), lanthana (La₂O₃), and zirconia (ZrO₂).

Rare earths may be applied to the substrate in a broad range of concentrations, for example, from 1 to 100 grams/liter. (i.e., grams of the element present, after application, per liter of final catalyst volume.) In one embodiment, cerium may be applied at a density of greater than 25, greater than 30, greater than 40 or greater than 50 grams/liter. In one embodiment, lanthanum may be applied at concentrations of greater than 10, greater than 15, greater than 20 or greater than or equal to about 21.7 grams/liter. Zirconium may be applied at any concentration, for example, greater than 20, greater than 30 or greater than 40 grams/liter. When zirconia, ceria and/or lanthana are used, the ZrO₂ may comprise from about greater than 0 to 67% of the total loading of SMSI promoters, CeO₂ may comprise from about 15-67% of the total and La₂O₃ may comprise about 8-25% of the total. One embodiment includes about 50.8 grams/liter cerium, 13 grams/liter lanthanum and about 31.8 grams/liter of zirconium. Of the total mass deposited on the support, alumina may account for a significant portion, for examples, 30, 40 or 50% of the total mass. Ceria may account for a smaller portion, for example, 15 or 20% of the total mass. Lanthana may account for 5 or 8% of the total mass, for example, and zirconia may account for around 8 or 12%, for example, of the total mass deposited on the support.

When alumina, Al₂O₃, is used, it may be preferred to include a high ratio of lanthanum to alumina, but an excessively high ratio of lanthanum to alumina may provide a catalyst having less activity. Useful ratios of aluminum to lanthanum on a molar basis are preferably in a range of about 1:1 to 1:12. The inclusion of La³⁺ may increase the dispersion of any precious metals as well as of CeO₂. It may also help to minimize or eliminate interaction between CeO₂ and Al₂O₃ by forming, for example, a LaAlO₃ passivation layer that may prevent the formation of CeAlO₃. The use of La³⁺ in a precious metal/CeO₂/Al₂O₃ catalyst may also improve oxygen storage capacity (OSC). This is believed to occur due to a higher diffusion rate of lattice oxygen and oxygen vacancies in lanthana-ceria crystallites.

It is also believed that O²⁻ mobility inside the fluorite lattice may be increased by doping the CeO₂ with zirconium. This may be due to the smaller crystal ionic radius of Zr⁴⁺ (0.84 A) compared to that of Ce⁴⁺ (0.97 A). The use of ZrO₂ may also increase the high O²⁻ mobility inside the fluorite lattice that is related to the high defective structure and lattice strain that results in a high reducibility of Ce⁴⁺ in Zr-doped CeO₂. Other elements having a crystal radius smaller than that of Ce⁴⁺ may also be used. These include Ti, Hf, V and Nb. (R. D. Shannon and C. T. Prewitt, Acta Cryst., B25, 925, (1969); D. Kim, J. Am. Chem. Soc. 72, 1415 (1989).

The catalyst may also include one or more, two or more, or three or more precious metals (PM). The precious metals may be chosen from those that are catalytically active, and preferably may be chosen from the group of platinum, palladium, rhodium and iridium, most preferably including each of platinum, palladium and rhodium. The three PMs may be used in any ratio found to efficiently reform the fuel of choice while resisting poisoning by sulfur-containing compounds. Platinum may be used, for example, to provide efficient reforming of aliphatics and because it exhibits good poison (sulfur) tolerance. Palladium may be used to provide, for example, efficient reforming of aromatics and olefins, and may also provide for increased conversion of CO to CO₂. Rhodium may exhibit good steam reforming characteristics. In one embodiment, the catalyst is free, or essentially free, of nickel.

Test results indicate a synergy when Pt, Pd and Rh are used together in the ATR catalyst, in the sense that the reforming efficiency for fuels containing diverse hydrocarbons is greater than what would be expected from the contribution of each of the precious metals individually. This synergy may be further enhanced through the use of other components, for example, rare earths such as cerium and lanthanum, used in conjunction with the precious metals, via the SMSI effect.

The bonding formation of PM-O—Ce, resulting in strong metal-support interaction (SMSI) between PM (Pt, Pd and Rh) and Ce is believed to contribute to improved sulfur tolerance. The strong bonding of PM-O—Ce renders attack by H₂S (which is produced during autothermal reforming of sulfur-containing fuels like gasoline to form sulfides) more difficult than without this kind of bonding. This SMSI is believed to be enhanced by the creation of oxygen vacancies and/or lattice strain that can result due to the introduction of other rare earths and other metals. The bonding strength of PM-O—Ce may be even stronger due to the creation of oxygen vacancies and/or lattice strain resulting from the introduction of La³⁺ and/or Zr⁴⁺ and/or Ti⁴⁺ to the active support. The SMSI in this instance may result in improved stability of the catalytic action during use, and particularly during use in adverse environments, such as with fuels containing measurable sulfur, and particularly with fuels including 10, 20, 30, 35, or greater, ppm S, by weight.

While some have suggested reducing the rare earth loading of catalysts to decrease the sulfur sensitivity for conversion of NMHC (non-methane hydrocarbons) (Bartley, Bykowski, Welstand and Lax, “Effects of Catalyst Formulation on Vehicle Emissions With Respect to Gasoline Fuel Sulfur Level” SAE Technical Paper Series, 1999-01-3675), it has been found that in one embodiment the introduction of greater amounts of these compounds actually may increase SMSI, and thus improve resistance to sulfur poisoning.

For example, platinum may be applied at a concentration of more than 5%, more than 10%, more than about 15, or about 15-30% of the precious metals, by weight. Palladium can be applied, for example, at a concentration of 20-70%, and in some embodiments at about 30% or about 50% of the total precious metals, by weight. In some embodiments, rhodium may be applied, for example, at a concentration of 5-20% of the precious metals, by weight. In another embodiment, a ratio of Pt:Pd:Rh of about 2:6:1, by weight, or a molar ratio of about 1.05:5.5:1.0, may be preferred. This ratio has been shown to provide efficient reforming of fuels such as California Phase II gasoline that may comprise aromatics, olefins, aliphatics and sulfur-containing compounds.

In another embodiment, the washcoat loadings for platinum may be from 1 to 10 grams/liter, and in one embodiment, about 1.4 grams/liter. For palladium, the washcoat loading may be from 2 to 20 grams/liter, and in one embodiment, about 4.24 grams/liter. For rhodium, the washcoat loading may be from about 0.3 to 5 grams/liter, and in one embodiment, about 0.7 grams/liter on the substrate. The substrate may include, for example, pellets or a monolith.

In another aspect, a system for reforming gasoline to hydrogen for use in a PEM based fuel cell is provided. Fuel, air and water are heated, mixed, and passed over a catalyst at a temperature from about 500 to about 900 deg. C., preferably about 550 to 750 deg. C., at a WGHSV (wet gas hourly space velocity) greater than 10,000 h⁻¹, greater than 40,000 h⁻¹, or greater than 65,000 h⁻¹. The resulting stream of hydrogen, water, carbon monoxide, carbon dioxide and other hydrocarbons may additionally be passed through a WGS reactor and also may be passed through a second WGS reactor. If additional carbon monoxide needs to be removed that is not converted by the catalyst or the optional WGS reaction, additional CO traps or chemical removal techniques such as the well-known Preferential Oxidation (PrOx) reaction may be employed to provide a hydrogen stream having, for example, less than about 10 ppm CO. The hydrogen stream may then be passed to the PEM.

In addition, because the fuel being reformed may contain sulfur, sulfur-containing compounds, such as H₂S in particular, may be present downstream of the reforming bed. Such compounds will normally be removed prior to the passage of the hydrogen stream to the PEM. Hydrogen sulfide traps and chemical techniques known to those skilled in the art may be used. Because the fuel has been reformed, complex sulfur-containing compounds such as thiophene are typically reduced to simpler sulfur compounds such as H₂S, which are easier to trap using standard methods. Hence, another aspect of the catalyst is that it can efficiently convert organic organo-sulfur sulfur compounds, for examples, thiophene and benzothiophene, into H₂S or other easily trapped forms of sulfur.

The catalyst body may be preheated prior to contact with a fuel mixture to provide efficient catalytic activity as soon as the fuel mixture contacts the catalyst body. The temperature may be raised to, or maintained at, for example, above 300° C., 400° C., 500° C., 600° C. or 700° C.

### EXAMPLES

### Example 1

An ATR catalyst was produced by first washcoat loading 0.12 grams/cm³ (equivalent to 120 g/liter) of gamma alumina onto a 900 cpsi cordierite monolith having a length of 3.81 cm and a diameter of 1.9 cm (Corning). The monolith was dried and calcined in air at 550° C. Next, cerium and lanthanum were added to the catalyst from a single solution using nitrate salts of each. The washcoat loading of the cerium was 0.05 grams/cm³ and for lanthanum was 0.013 grams/cm³. The monolith was again dried and calcined in air overnight at 550° C. Zirconium was then added to the catalyst from a zirconium nitrate solution in five steps to reach a washcoat loading for zirconium of 0.032 grams/cm³. Again the monolith was dried and calcined overnight at 550° C. The resulting molar ratio among the non-precious metals Ce, La, and Zr was 4:1:4. (The weight ratio of the oxides of Ce:La:Zr:Al is about 2:1:2:6).

Precious metals platinum, palladium and rhodium were then added from a single solution essentially free of chloride salts. The monolith was dried and calcined again at 550° C. to result in a total precious metals loading of 5.5 g/L in a Pt:Pd:Rh weight ratio of 2:6:1.

The final composition of the catalyst included (per liter of catalyst volume):

CeO₂—50.8 g/L Ce

La₂O₃—13 g/L La

ZrO₂—31.8 g/L Zr

Al₂O₃—122 g/L Al₂O₃

5.5 g/L of Pt, Pd and Rh, in a weight ratio of 2:6:1, respectively. The ratio, by weight, of cerium:lanthanum:PM was about 8:2:1.

A series of experiments was run to determine the reforming efficiency of the catalyst. Unless otherwise noted, the fuel tested was a California Phase II gasoline having a specific gravity of 0.7377 grams/cm³, a distillation range of 102 to 367° F. (about 38° C. to about 186° C.), a sulfur content of about 35 ppm by weight, and a hydrocarbon content of 24.3% aromatics, 4.9% olefins and 10.9% MTBE as tested per ASTM D1319.

The 900 cpsi monolith provided for a relatively low pressure drop across the catalyst body when compared to that obtained in a packed bed type catalyst. Pressure drop becomes more significant with an increase in wet gas space velocity. The catalyst was placed in a reactor that was electrically heated to maintain a desired temperature range of 550 to 900° C. Thermocouples above the catalyst measured temperature at the catalyst body inlet and thermocouples below the catalyst measured temperature at the catalyst body outlet.

The water and air were mixed and pre-heated to between 500 and 550° C. The fuel was preheated from 170 to 200° C. The air, water and fuel were then mixed and then contacted with the catalyst. The flow of the air, water and gasoline mixture to the catalyst was controlled by either a mass flow controller or HPLC pumps to result in a molar ratio of water to carbon (“steam to carbon ratio”, or S/C ratio) of 2.3 and a Φ (effective ratio of fuel to oxygen) of 3.7. Results show that all of the oxygen was reacted. The temperature difference between the inlet and outlet temperatures varied by about 50° C. to 100° C., depending on the actual temperature and on the wet gas space velocity. It is believed that the catalyst inlet temperature is typically higher than the catalyst outlet temperature due to the exothermic partial oxidation reaction that takes place near the inlet of the catalyst. It is also believed that the temperature then drops toward the outlet of the catalyst because a steam reforming catalysis, which is endothermic, starts to dominate over the partial oxidation reaction. Prior to analysis, the product gas was cooled and any unreacted water was condensed. At some lower reaction temperatures, some unreacted hydrocarbons were also condensed. The dry gas composition was monitored by gas chromatography and results were recorded. A sample of uncooled product was introduced to MS/GC simultaneously for residue byproduct analysis.

In a first experiment, the system was operated at a WGHSV of 40,000 h⁻¹ over a temperature range at the outlet of about 640° C. to about 790° C. The fuel to oxygen ratio was adjusted to a Φ value of 3.7. The fuel stream was analyzed for hydrogen, carbon dioxide, carbon monoxide and methane content.

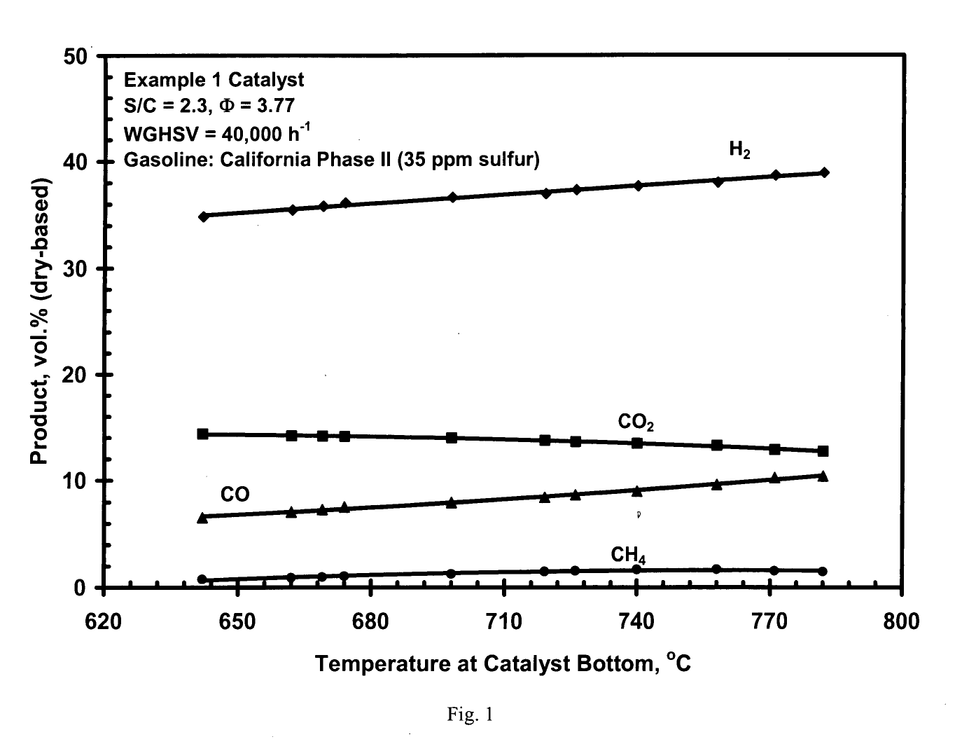

Results are presented in FIG. 1 and show that over the outlet temperature range tested, the hydrogen content of the product stream was greater than 35 vol. %. Volume percent hydrogen was at least 35% and methane content was consistently less than 3%. The rise in the sum of H₂, CO, CO₂, and methane as temperature increased reflects a rise in total gasoline conversion towards 100%. This indicates that the catalyst was fully utilized under these conditions. There was no sign of sulfur poisoning (decreased efficiency) during the experiment, which was run for several hours at increasing temperatures to collect the data illustrated in FIG. 1.

### Example 2

A previously disclosed catalyst formulation designed as an exhaust emission control catalyst for automotive use (Bartley, Bykowski, Welstand and Lax, “Effects of Catalyst Formulation on Vehicle Emissions With Respect to Gasoline Fuel Sulfur Level” SAE Technical Paper Series, 1999-01-3675) was formed on a monolith in the same manner as that of Example 1. The molar ratios of precious metals, rare earths and alumina used were as follows: PMs, 0.5 Pt, 1.50 Pd and 0.25 Rh (mole ratios); other metals and alumina, 0.5 CeO₂, 0.125 La₂O₃, 1.0 ZrO₂ and 1.5 Al₂O₃ (mole ratios based on metal content). The materials were washcoated onto a 900 cpsi cordierite monolith. The composition by weight was:

CeO₂—25.4 g/L Ce

La₂O₃—6.5 g/L La

ZrO₂—31.8 g/L Zr

Al₂O₃—61 g/L Al₂O₃

5.5 g/L of Pt, Pd and Rh, in a ratio of 2:6:1

One of the differences in composition from the catalyst of FIG. 1 lies in reduced amounts of ceria, lanthana and alumina at similar amounts of zirconia and PMs. This reduction in supporting metals is expected to decrease the SMSI (strong metal-support interaction) of the system.

An experiment was performed to determine the reforming efficiency of this catalyst. The fuel was the same California Phase II used in Example 1. The system was operated at substantially the same conditions as in FIG. 1: a WGHSV of 40,000 h⁻¹ over a temperature range of about 700° C. to about 820° C. The fuel to oxygen ratio was adjusted to a Φ of 3.77. Fuel, air and water were mixed prior to passage through the monolith using the same technique as in Example 1. The reformed fuel stream was analyzed for hydrogen, carbon dioxide, carbon monoxide and methane content.

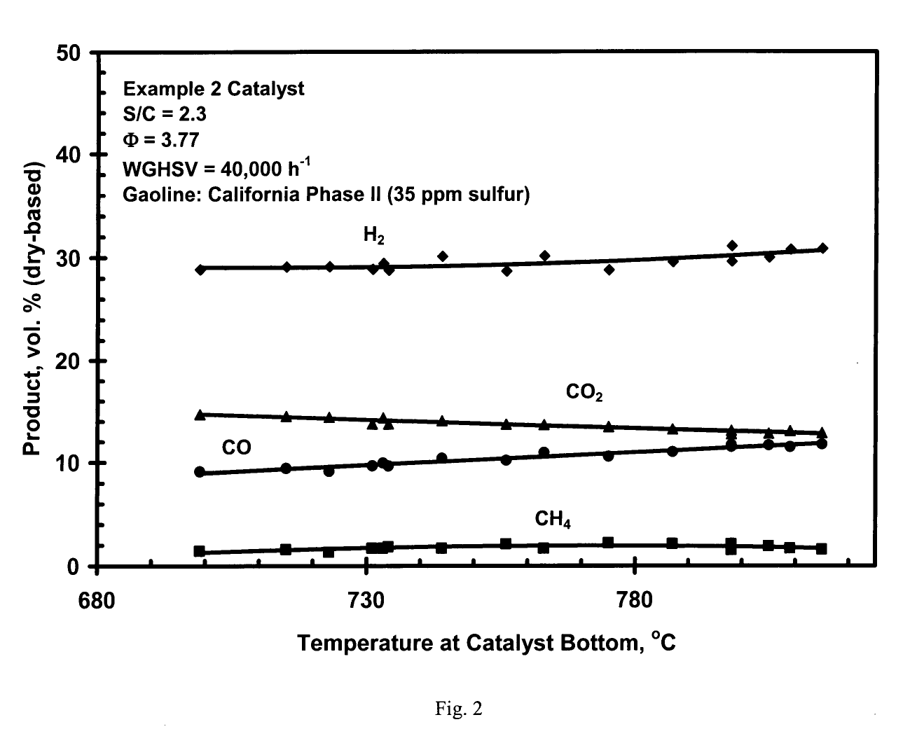

Results are presented in FIG. 2. Total conversion rose slightly with temperature, indicating full utilization of the catalyst. Volume percent hydrogen was about 30%. The material of Example 2 had a significantly lower yield of hydrogen (for example about 30% by volume at 780 deg. C., vs. about 39% with the catalyst of Example 1), and also a slightly higher methane yield (an undesirable side reaction) compared to the material shown in FIG. 1

### Example 3

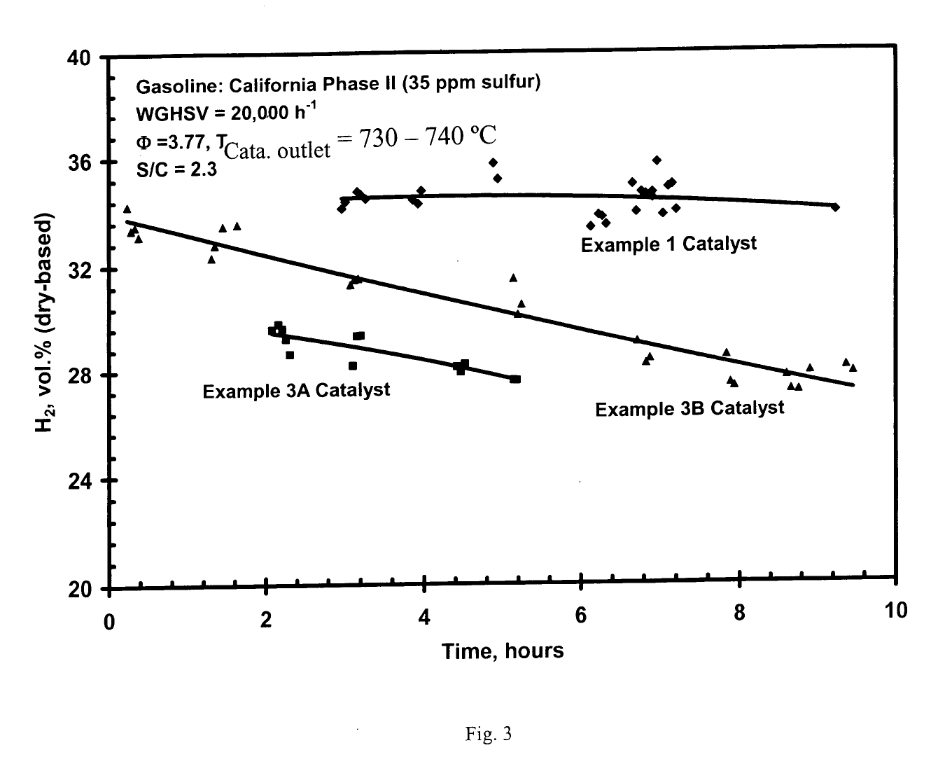

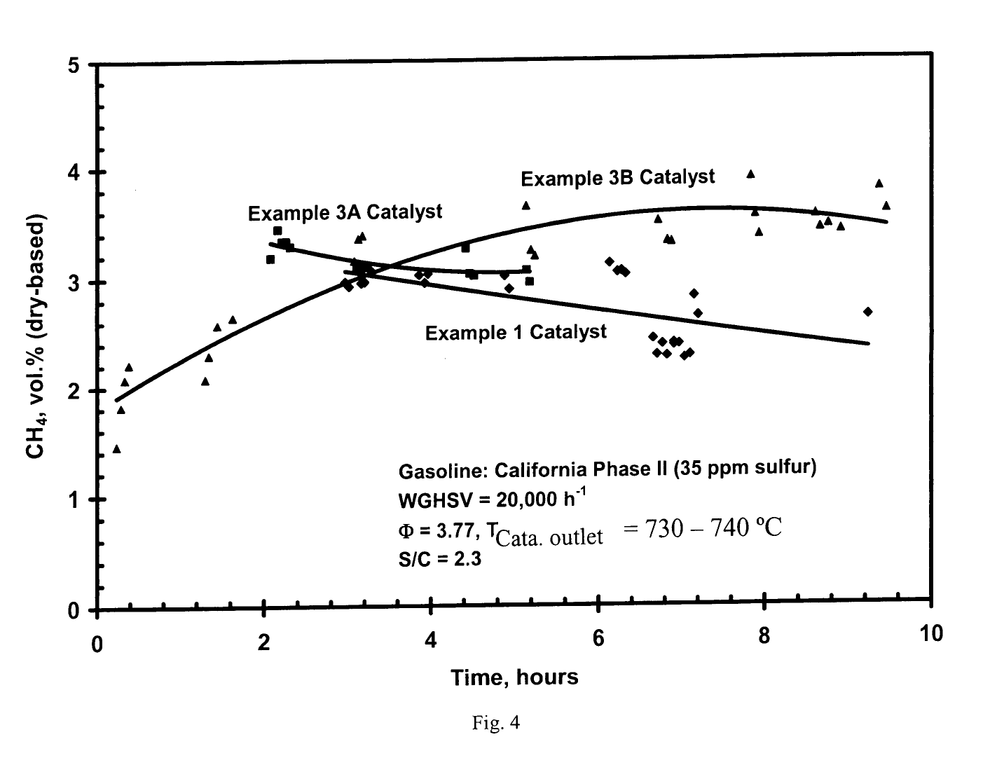

In order to compare productivity and sulfur tolerance of the catalyst of Example 1 with commercially available catalysts, an experiment was run on three different catalysts using a fuel containing 35 ppm sulfur. The fuel used was California Phase II Gasoline. Hydrogen output and methane output were both monitored. The results are shown in FIG. 3 and FIG. 4. The catalyst of Example 1 (diamonds) is compared to two commercially available fuel reforming catalysts. Example 3B Catalyst (triangles) is formulation 383™ from the “dmc²” division of OMG AG (Germany), washcoated on a 900 cpsi cordierite monolith, comparable to that used in Example 1. Example 3A Catalyst (squares) is the same 383™ formulation on a 600 cpsi FeCrAlloy® metal monolith. (The loading of these washcoats onto FeCrAlloy alloy and other metals is in about the same range of added weight per liter as on to cordierite.)

The three catalysts were run for 10 hours on standard California Phase II gasoline, containing 35 ppm sulfur. The WGHSV was 20,000 hr⁻¹, the steam to carbon ratio was 2.3, and the Φ was 3.7. The catalyst of Example 1 (diamonds) and the 383™-cordierite sample (Example 3B catalyst; triangles) started with comparable hydrogen yields (volume percent) of about 34%. (FIG. 3). Over the course of the run, the Example I catalyst lost less than 5% of its activity. The Example 3B (383™) catalyst, in contrast, lost over 20% of its activity, in an approximately linear fashion, with time. The 383™ catalyst on the 600 cpsi substrate (Example 3A, squares) had comparable losses to the first 383™ catalyst.

In FIG. 4, methane creation is shown for the same experiment. The material of Example 1 (Example 1 catalyst; black diamonds) improved during the experiment (i.e., methane yield (volume percent) decreased), while the commercial material on cordierite (Example 3B catalyst) deteriorated for the first 6 hours, and the commercial formulation on FeCrAlloy® (Example 3A catalyst, squares) improved slightly before plateauing at a level above that of the experimental material.

At the start of the experiment, hydrogen production efficiencies for the catalysts of Example 1, catalyst 3B and catalyst 3A were 37%, 36%, and 35% respectively. After 5 hours, the hydrogen production efficiencies of Example 1, catalyst 3B and catalyst 3A were 35%,28% and 30%.

In additional experiments, not shown, all three catalysts operated for many (hundreds) of hours with a sulfur-free fuel without significant loss of activity. Therefore, the observed loss of hydrogen-forming activity can be attributed to the presence of sulfur in the fuel. In the sulfur environment, the material of Example 1 provided improved results over the commercial material.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method comprising:
passing a fuel comprising at least about 1 ppm, by weight, of sulfur, over a catalyst comprising platinum; and
reforming the fuel to hydrogen at a hydrogen volume percent productivity rate that decreases by less than 1% per hour of operation.

2-4. (canceled)

5. The method of claim 1 wherein the fuel comprises at least about 35 ppm by weight of sulfur.

6-7. (canceled)

8. The method of claim 1 wherein the fuel is passed over the catalyst at a WGHSV of greater than or equal to 20,000 h⁻¹.

9. (canceled)

10. The method of claim 1 wherein the fuel is passed over the catalyst at a WGHSV of greater than or equal to about 65,000 h⁻¹.

11-12. (canceled)

13. The method of claim 1 wherein the temperature of the catalyst is between about 700-800 degrees Celsius.

14. (canceled)

15. The method of claim 1 wherein the hydrogen volume percent productivity rate is greater than 90% of an original value after 5 hours of operation.

16-18. (canceled)

19. A system comprising a catalyst in fluid communication with a fuel cell membrane wherein the catalyst comprises a support, three precious metals disposed on the support and cerium disposed on the substrate at a density of greater than 30 g/L.

20. The system of claim 19 wherein the precious metals comprise platinum, palladium and rhodium.

21. The system of claim 19 wherein the fuel cell membrane is a PEM.

22. The system of claim 19 wherein the support comprises a monolith.

23. The system of claim 22 wherein the monolith comprises ceramic.

24-25. (canceled)

26. The system of claim 19 wherein alumina, lanthanum, cerium and zirconium are disposed in a total combined amount of at least about 150 g/L of support volume.

27. The system of claim 19 wherein alumina comprises at least about 30% of the mass disposed on the support.

28-35. (canceled)

36. The system of claim 19 wherein the precious metals are disposed in a combined amount of at least about 4 g/L of support volume.

37. (canceled)

38. The system of claim 19 wherein the precious metals comprise platinum, palladium and ruthenium.

39-45. (canceled)

46. The system of claim 19 wherein the support is a ceramic material, and the ceramic material is selected from cordierite, alumina, silica, titania, zirconia, and mixtures thereof.

47. A method of producing a catalyst comprising:
washcoating alumina onto a substrate to provide an alumina concentration of greater than 100 g/L of catalyst volume;
washcoating cerium onto the substrate to provide a cerium concentration of greater than 30 g/L of catalyst volume;
washcoating lanthanum onto the substrate to provide a lanthanum concentration of greater than 7 g/L of catalyst volume; and
washcoating at least three precious metals onto the substrate, the precious metals comprising platinum, palladium and rhodium.

48. The method of claim 47 wherein the substrate comprises a monolith.

49. The method of claim 48 wherein the monolith is ceramic.

50. The method of claim 49 wherein the cerium, lanthanum and precious metals are provided at a weight ratio of about 8:2:1.

51-52. (canceled)
